(19) United States
(12) Patent Application Publication
(10) Pub. No.: US 2013/0015642 A1
(43) Pub. Date: Jan. 17, 2013

(54) BONNET AIRBAG

(71) Applicants: RAKIBUL ISLAM, Rancho Cucamonga, CA (US); ROBERT W. TRIMBLE, Gainesville, TX (US); RAUL DANIEL FLORES AGUIRRE, Chihuahua (MX); FREDERIC QUATANENS, Issoudon (FR); JEREMY CAILLETEAU, St. Aout (FR); JEREMY GAUDIN, Saint-Maur (FR); VIRGILE MARTINEZ, Segry (FR); JEAN-MARC OBADIA, Maubec (FR)

(72) Inventors: RAKIBUL ISLAM, Rancho Cucamonga, CA (US); ROBERT W. TRIMBLE, Gainesville, TX (US); RAUL DANIEL FLORES AGUIRRE, Chihuahua (MX); FREDERIC QUATANENS, Issoudon (FR); JEREMY CAILLETEAU, St. Aout (FR); JEREMY GAUDIN, Saint-Maur (FR); VIRGILE MARTINEZ, Segry (FR); JEAN-MARC OBADIA, Maubec (FR)

(73) Assignee: ZODIAC AEROSPACE, Issoudon (FR)

(21) Appl. No.: 13/428,141

(22) Filed: Mar. 23, 2012

Related U.S. Application Data
(60) Provisional application No. 61/506,694, filed on Jul. 12, 2011.

(51) Int. Cl. B60R 21/207; B23P 11/00

(52) U.S. Cl. 280/730.1; 29/428

(57) ABSTRACT

Embodiments of the present invention provide a bonnet airbag system that is configured to deploy in a forward manner from a back portion of a seat.

### CROSS REFERENCE TO RELATED APPLICATIONS

This application claims the benefit of U.S. Provisional Application Ser. No. 61/506,694, filed Jul. 12, 2011, titled “Bonnet Airbag,” the entire contents of which are hereby incorporated by reference.

### FIELD OF THE INVENTION

Embodiments of the present invention relate generally to airbags for use in passenger transport vehicles. The airbags are designed to safely interrupt a passenger's forward momentum in the event of a crash condition.

### BACKGROUND

Airbags are occupant restraining devices, which typically include a flexible envelope or “bag” that is designed to inflate rapidly during a collision in order to prevent the vehicle's occupants from striking interior objects located in front of (or, in some cases, on the side of) the occupant. In automobiles, airbags are designed to prevent occupants from striking the steering wheel, the vehicle door, a window, or any other interior objects. In aircraft, airbags are designed to prevent passengers from striking the seat in front each passenger, the tray tables, a window, or any other interior objects. Airbags on passenger rail cars (such as trains, monorails, trolleys), motorcycles, and other passenger transport vehicles work similarly.

Most modern vehicles contain multiple airbags. For example, most automobiles provide an airbag in front of each occupant seating position (at least in the front seat), to protect the head and torso. They may also contain knee airbags, which protect the occupant's knees and legs. Most aircraft provide airbags either positioned in the back of each seat (so as to deploy for the passenger sitting behind that seat) or in the seat belts. For example, passengers sitting in the front seat or bulkhead in the aircraft do not have a seat in front of them, so in this instance, the airbag may be positioned in the passenger seat belt. Passenger vehicles may also contain airbags in side locations, which can inflate between an occupant and the vehicle door or the vehicle window or wall.

Typically, sensors deploy one or more airbags in an impact zone at variable rates based on the type and severity of impact. Most airbags are designed to only inflate in moderate to severe frontal crashes. Airbags are normally designed with the intention of supplementing the protection of an occupant who is correctly restrained with a seatbelt.

Since their invention in the early 1950s and introduction in the mid-1970s, airbags have continually been improved upon. However, further airbag improvements are desirable, including airbags that have varying designs for varying types of seating arrangements in passenger vehicles.

### BRIEF SUMMARY

Embodiments of the invention described herein thus provide airbags designed to deploy from a back of a seat in a forward manner in order to envelope at least an upper portion of a vehicle occupant's torso.

### BRIEF DESCRIPTION OF THE DRAWINGS

FIG. 1 shows a side perspective view of one embodiment of a bonnet airbag in its deployed position.

FIG. 2 shows a side perspective view of a bonnet airbag with an additional support feature.

FIG. 3 shows a side perspective view of a bonnet airbag with an alternate additional support feature.

FIG. 4 shows an aircraft seat with a bonnet airbag installed thereon.

FIG. 5 shows a cross sectional view of one embodiment of a storage position of a bonnet airbag.

FIGS. 6-9 show one embodiment of the progression of deployment of a bonnet airbag.

### DETAILED DESCRIPTION

Rather than causing an airbag to deploy from a location in front of or on the side of a passenger, the embodiments described herein provide an airbag that is designed to deploy from behind a passenger and extend over at least a portion of the passenger's upper body. For example, passengers seated in a front seat or bulkhead of an aircraft do not have a seat positioned in front of them from which an airbag may be deployed. Accordingly, the airbags for these seats are typically positioned in the passenger seat belt. However, seat belt airbags have several problems, in that they are uncomfortable for the passenger due to the increased weight of the seat belt and the stiffness of the belt. They can also make handling and positioning the seat belt more difficult. There may also be other instances when an airbag that deploys from a behind a passenger to the forward condition may be useful.

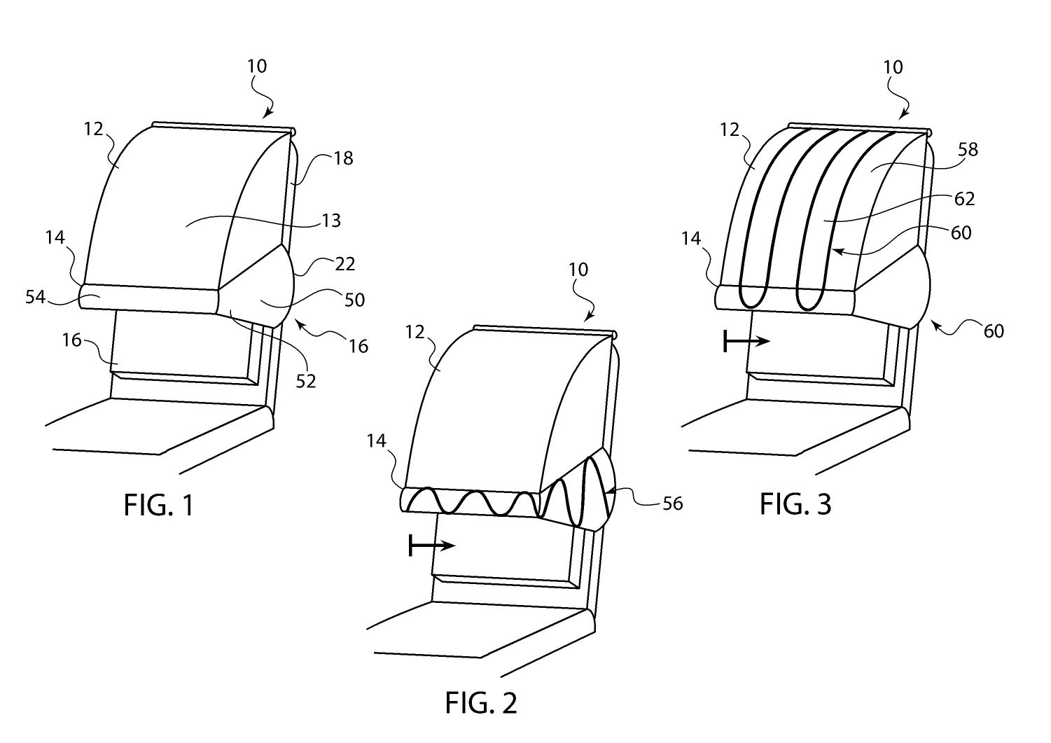

Accordingly, embodiments of the present invention provide a bonnet airbag having a bonnet hood that is associated with a seat back. The airbag deploys from behind the seat and moves forward to enclose or envelope at least an upper portion of the seat occupant's body within the bonnet airbag. Various embodiments of the bonnet airbag are illustrated in FIGS. 1-3.

Various bonnet airbags 10 are shown in FIGS. 1-3 in their deployed positions. The airbags 10 have a curved hood 12 and a lower support section 14. The bonnet airbags 10 are designed to deploy in a forward manner from a back portion of a seat. The lower support section 14 is generally provided as an inflatable flange 14, but it should be understood that any appropriate support section may be used, as long as it is capable of deploying immediately upon a detected crash condition and supporting the curved hood 12. Lower support section 14 will typically inflate, as this is the currently-known fastest and safest way to quickly deploy, but it should be understood that other options may be used for deployment of flange 14, such as a foam flange, or any other options that may be developed in the future.

The airbag 10 is secured to a seat 16 having a backrest 18. In a specific embodiment, the seat 16 is designed as an aircraft seat, but it should be understood that seat 16 may be any seat that is designed for use on board a passenger transport vehicle, such as an automobile seat, a train seat, or any other appropriate occupant seat in a vehicle. Each side of the bonnet airbag 10 is secured to the seat 16 along a middle area 20 of the backrest via one or more seat securement portions 22. It should be understood that bonnet airbag 10 may be positioned anywhere along the seat back, such as at the lower part of the seat back, at the upper part of the seat back, or even on or within a back part of the headrest, if one is provided on the seat back.

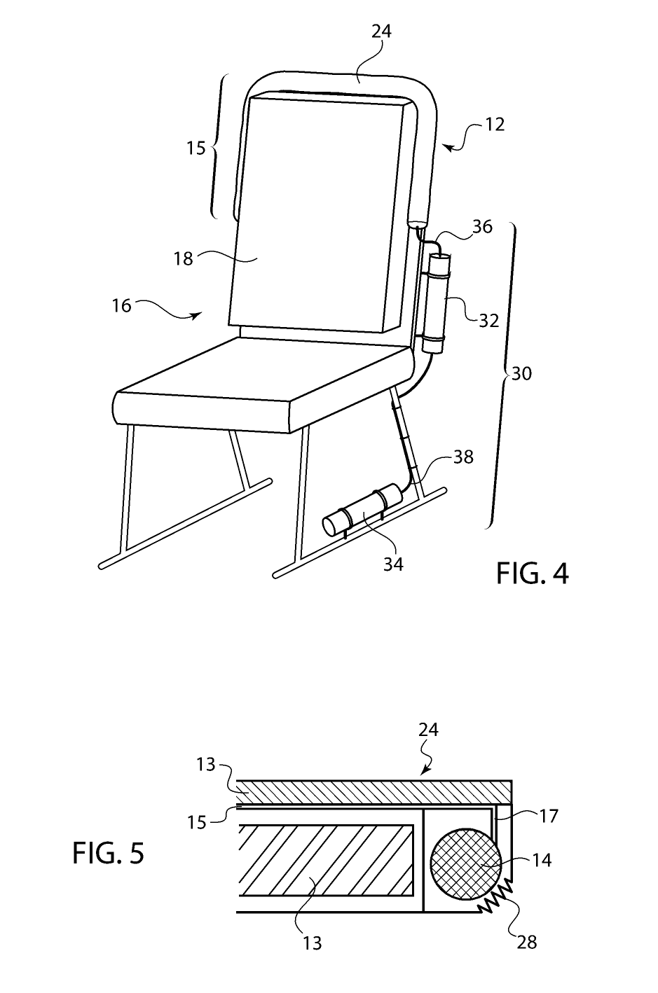

The curved hood 12 may be formed of a fabric 13 that is designed to form a bonnet or a curved bonnet when deployed. As shown in FIGS. 4 and 5, in a specific embodiment, the fabric 13 of the hood 12 has side edges 15 that are attached to the seat backrest 18 and a lower free end 17 that is secured to the inflatable flange 14. The inflatable flange 14 may also have edges that are secured to the seat back 18. In one embodiment, the bonnet airbag 10 is secured to the seat 16 such that it is stored around the backrest foam 13, inside a cover 24. An example of this storage position is shown in FIG. 4, and a cross-sectional view of the components positioned inside the cover is shown in FIG. 5. The airbag 10 may be secured at sides of the backrest and optionally, along the top of the back rest as well. In normal use (when not deployed), the airbag stays confined in this storage position. The cover 24 may formed of a coverage fabric that is designed to conceal the airbag 10 until use. Coverage fabric may be of a similar fabric and design as that of the seat back, so as to conceal the airbag 10 until use. The cover 24 may also feature a breakable seam 28, which is designed to break and allow quick and unencumbered employment of the airbag 10 in a crash condition.

The inflatable flange 14 is configured to inflate upon detection of a crash condition, such that it expands and creates a lower support section for hood 12. In a particular embodiment, the inflatable flange 14 expands and springs or shoots upwardly and the forwardly. The embodiment that provides the airbag 10 attached at or along about the middle portion 20 of the seat 16 allows the inflatable flange 14 to extend over and around the upper portion of the passenger's torso. In certain embodiments, the bonnet may be designed to be of such a size and shape that allows it extend over a middle portion of the passenger's torso as well. Upon deployment, inflation of the flange 14 causes the bonnet hood 12 to move from its stowed position, and the inflatable flange 14 surrounds a passenger or seat occupant at or about the portions of the torso. The bonnet hood 12 then envelopes an upper part of the passenger and creates a barrier to forward movement.

In a specific embodiment, the flange 14 may have a triangular or cone shape 50 at its fixation/seat securement area 22, which narrows to a narrower section 52 slightly forward thereof. This shape helps stabilize the bonnet when it is in the deployed position. The front portion 54 may be generally straight, as shown in the Figures, or it may be curved, angled, or shaped otherwise.

In the embodiment shown in FIG. 2, the airbag 10 has an additional support feature 56. Support feature 56 may be a braid (such as a knitted or woven braid) that retracts or becomes shorter when the flange 14 inflates. By retracting upon inflation, the braid creates a slight tension on the flange 14 and thus, the airbag 10 as a whole. This reinforcing material may be added over the tube that forms the flange, inside the tube that forms the flange, or it may be formed integrally with the material that forms the flange. By retracting upon inflation, the braid creates a slight tension on the flange 14 and thus, the airbag 10 as a whole. This reinforcing material may be added over the tube that forms the flange, inside the tube that forms the flange, or it may be formed integrally with the material that forms the flange.

In the embodiment shown in FIG. 3, the curved portion 58 of the hood 12 has an additional support feature 60. Support feature 60 may be one or more elongated inflatable tubes, one or more shape memory wires, or any other appropriate support feature. Support feature 60 may be provided in order to help the hood fully and quickly deploy. If support feature 60 is provided as one or more inflatable tubes 62, the tubes may be rounded and their deployment helps the airbag create a better surround for the passenger. The tubes 62 may be secured to the fabric 13 that forms the hood 12. The tubes 62 may be fluidly connected to flange 14 or they may be provided as separately inflatable entities.

Each seat includes a system 30 designed to deploy the airbag when needed, at the appropriate time. In one particular embodiment, a gas inflator 32 and a crash sensor 34 are mounted on or otherwise associated with the seat 16. For example, these elements may be positioned on the side portion of the seat, as shown in FIG. 4, or they may be positioned underneath the seat, or they may be incorporated into other portions of the seat. The gas inflator 32 contains gas under high pressure that is restrained with a valve. The crash sensor 34 is equipped with an accelerometer sensor that is designed to detect a crash condition. The gas inflator 32 and the inflatable flange 14 are fluidly linked via a hollow tube 36. The gas inflator 32 and the crash sensor 34 are linked via electric wiring 38, although it should be understood that wireless communication may be used.

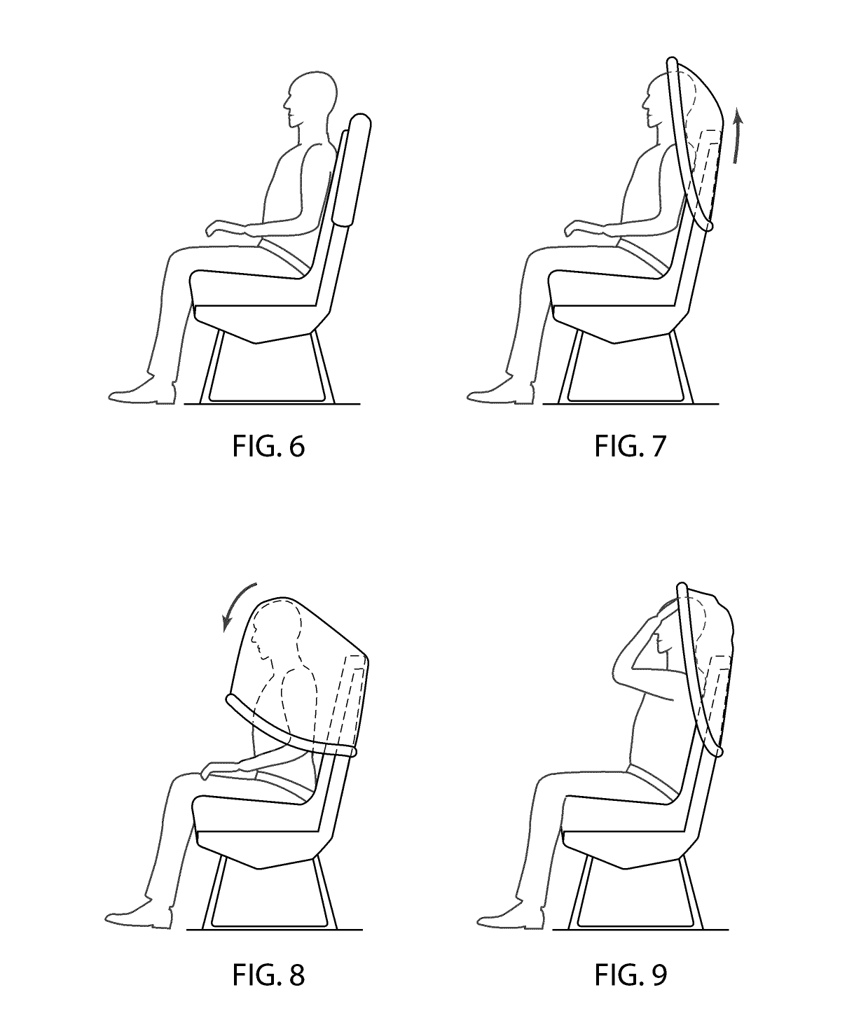

In normal use, the airbag 10 maintains its stored position, as shown in FIGS. 4 and 6. When a crash condition occurs, the crash sensor 34 detects an abnormal acceleration and sends a signal to the gas inflator 32 with the electric wiring 38 to open the valve. The gas flows on the hollow tube 36 from the gas inflator 32 to the inflatable flange 14. The inflatable flange 14 inflates by expanding out of the coverage fabric of the cover 24 by breaking the breakable seam 28. The flange 14 is then first deployed upward, as shown in FIG. 7. In a specific embodiment, the airbag moves from its stowage position to its deployed position in about 20-40 milliseconds. After moving above the passenger, the flange then deploys in a downward direction in order to pass over the passenger, as shown in FIG. 8. The curved bonnet hood 12, which is attached to the flange 14, follows the flange 14 and envelops at least an upper portion of the passenger to prevent impact. A passenger having a bonnet airbag 10 completely deployed over an upper torso area in illustrated in FIG. 8. After the crash, the passenger lifts the airbag 10 and evacuates the vehicle. An example of this configuration is shown in FIG. 9.

Changes and modifications, additions and deletions may be made to the structures and methods recited above and shown in the drawings without departing from the scope or spirit of the invention and the following claims.

What is claimed is:

1. A seat equipped with an airbag that deploys in a forward manner from a back portion of the seat, comprising:
a seat backrest;
a bonnet airbag associated with the seat backrest, the bonnet airbag shaped and configured such that such that upon deployment, the bonnet airbag moves forward to at least partially surround a portion of an occupant of the seat.

2. The seat of claim 1, wherein the bonnet airbag comprises a curved bonnet hood and a lower support portion.

3. The seat of claim 2, wherein the lower support portion comprises an inflatable flange.

4. The seat of claim 1, wherein the bonnet airbag has a stowed position provided by a cover.

5. The seat of claim 4, wherein the cover further comprises a breakable seam.

6. The seat of claim 1, wherein the bonnet airbag is attached along sides the seat backrest.

7. The seat of claim 1, wherein the bonnet airbag has a triangular cone shape at or near a point at which the airbag is attached to the seat backrest.

8. The seat of claim 1, further comprising a system for detecting a crash condition and causing the airbag to deploy.

9. The seat of claim 8, wherein the system comprises a gas inflator and a crash sensor.

10. The seat of claim 1, wherein the airbag has one or more additional support features.

11. The seat of claim 10, wherein the one or more additional support features comprise a braid at the front portion of the airbag that is configured to retract upon airbag deployment.

12. The seat of claim 10, wherein the one or more additional support features comprise one or more inflatable tubes configured to support a hood portion of the airbag upon airbag deployment.

13. An airbag designed to deploy in a forward manner from a back portion of a seat, comprising:
a bonnet hood; and
a lower support.

14. The airbag of claim 13, wherein the lower support portion comprises an inflatable flange.

15. The airbag of claim 13, wherein the airbag has one or more additional support features.

16. The airbag of claim 15, wherein the one or more additional support features comprise a braid at the front portion of the lower support that is configured to retract upon airbag deployment.

17. The airbag of claim 15, wherein the one or more additional support features comprise one or more inflatable tubes configured to support the bonnet hood of the airbag upon airbag deployment.

18. The airbag of claim 13, further comprising a system for detecting a crash condition and causing the airbag to deploy.

19. The airbag of claim 13, wherein the lower support has a triangular cone shape at or near a point at which the airbag is attached to a seat backrest.

20. A method for installing an airbag in a seat in order for the airbag to deploy from a back portion of the seat, comprising:
(a) providing an airbag designed to deploy in a forward manner from a back portion of a seat, (b) providing a system for detecting a crash condition and causing the airbag to deploy;
(c) securing the airbag to the seat;
(d) securing the system at a location that enables it to communicate with an activate the airbag upon a crash condition.
